(19) United States
(12) Patent Application Publication
(10) Pub. No.: US 2024/0350360 A1
(43) Pub. Date: Oct. 24, 2024

(54) Plasma Storage Container

(71) Applicant: Fenwal, Inc., Lake Zurich, IL (US)

(72) Inventors: Daniel M. Karlovsky, Cary, IL (US); Christine Gandor, Arlington Heights, IL (US); Courtney Westrich, Spring Grove, IL (US); Ryan G. Murphey, Burlington, WI (US); Michael R. Jacobs, Lake Zurich, IL (US); Alexandra Salomon, Chicago, IL (US); Walter Timothy Watts, Lake Forest, IL (US); Patrick Flanagan, Algonquin, IL (US)

(21) Appl. No.: 18/641,483

(22) Filed: Apr. 22, 2024

Related U.S. Application Data
(60) Provisional application No. 63/461,340, filed on Apr. 24, 2023.

(51) Int. Cl. A61J 1/05; A61J 1/14

(52) U.S. Cl. CPC A61J 1/05; A61J 1/1475

(57) ABSTRACT

A plasma storage container includes a bottle, with a connector (which may be unitarily formed) connected to a neck of the bottle. A gasket may be positioned between the neck and the connector to provide a seal along an interface therebetween. Inlet and outlet tubes are connected (e.g., via bonding) to the connector, with the connector defining an inlet flow path from the inlet tube to the interior of the bottle and an outlet flow path from the interior of the bottle to the outlet tube. A bottom end of the inlet flow path may extend farther into the interior of the bottle than the bottom end of the outlet flow path.

### CROSS-REFERENCE TO RELATED APPLICATIONS

This application claims the benefit of and priority of U.S. Provisional Patent Application Ser. No. 63/461,340, filed Apr. 24, 2023, the contents of which are incorporated by reference herein.

### BACKGROUND

### Field of the Disclosure

The present disclosure generally relates to storage of biological fluids. More particularly, the present disclosure relates to containers or bottles for storing plasma that has been separated from blood.

### Description of Related Art

Various blood processing systems now make it possible to collect particular blood constituents, rather than whole blood, from a blood source. Typically, in such systems, whole blood is drawn from a source, the particular blood component or constituent is removed and collected, and the remaining blood constituents are returned to the source.

Whole blood is frequently separated into its constituents through centrifugation. This requires that the whole blood be passed through a centrifuge after it is withdrawn from, and before it is returned to, the source. To avoid contamination and possible infection of the source, the blood is preferably contained within a sealed, sterile fluid flow system during the entire centrifugation process. Typical blood processing systems thus include a permanent, reusable centrifuge assembly containing the hardware (drive system, pumps, valve actuators, programmable controller, and the like) that spins and pumps the blood, and a disposable, sealed and sterile fluid processing assembly that is mounted in cooperation on the hardware. The centrifuge assembly engages and spins a disposable centrifuge chamber of the fluid processing assembly during a collection procedure. The blood, however, makes actual contact only with the fluid processing assembly, which assembly is used only once and then discarded.

As the whole blood is spun by the centrifuge, the heavier (greater specific gravity) components, such as red blood cells, move radially outwardly away from the center of rotation toward the outer or “high-G” wall of the separation chamber. The lighter (lower specific gravity) components, such as plasma, migrate toward the inner or “low-G” wall of the separation chamber. Various ones of these components can be selectively removed from the whole blood by forming appropriately located channeling seals and outlet ports in the separation chamber.

While many blood separation systems and procedures have employed centrifugal separation principles, there is another class of devices, based on the use of a membrane, that has been used for plasmapheresis (i.e., separating plasma from whole blood). More specifically, this type of device employs relatively rotating surfaces, at least one or which carries a porous membrane. Typically, the device employs an outer stationary housing and an internal spinning rotor covered by a porous membrane.

Well-known plasmapheresis devices include the Autopheresis-C® and Aurora separators sold by Fenwal, Inc. of Lake Zurich, Illinois, which is an affiliate of Fresenius Kabi AG of Bad Homburg, Germany. A detailed description of an exemplary spinning membrane separator may be found in U.S. Pat. No. 5,194,145, which is incorporated by reference herein. This patent describes a membrane-covered spinner having an interior collection system disposed within a stationary shell. Blood is fed into an annular space or gap between the spinner and the shell. The blood moves along the longitudinal axis of the shell toward an exit region, with plasma passing through the membrane and out of the shell into a collection bag. The remaining blood components, primarily red blood cells, platelets, and white blood cells, move to the exit region between the spinner and the shell and then may be collected, returned to a blood source, or discarded.

Spinning membrane separators have been found to provide excellent plasma filtration rates, due primarily to the unique flow patterns (“Taylor vortices”) induced in the gap between the spinning membrane and the shell. The Taylor vortices help to keep the blood cells from depositing on and fouling or clogging the membrane.

These blood separation techniques are not incompatible, but may be employed in combination to execute a variety of blood separation procedures, as described in PCT Patent Application Publication No. WO 2018/053217 A1, which is hereby incorporated herein by reference. In addition to these two approaches, a variety of other types of blood separation techniques are also known and routinely used to separate blood into two or more constituents.

Regardless of the manner in which blood is separated into its constituents, the components to be collected are typically individually stored (e.g., with packed red blood cells being stored separately from a platelet product, with these two components being stored separately from a plasma product) and used to treat a variety of specific conditions and diseased states. These components can be stored and/or transported in a bag or bottle any other suitably configured container. An exemplary container or bottle for storing plasma is described in U.S. Pat. No. 8,961,489, which is hereby incorporated herein by reference. Conventional plasma storage containers or bottles are subject to various disadvantages and limitations, such that it would be advantageous to provide a plasma storage container or bottle that improves upon the conventional designs.

### SUMMARY

There are several aspects of the present subject matter which may be embodied separately or together in the devices and systems described and claimed below. These aspects may be employed alone or in combination with other aspects of the subject matter described herein, and the description of these aspects together is not intended to preclude the use of these aspects separately or the claiming of such aspects separately or in different combinations as set forth in the claims appended hereto.

In one aspect, a plasma storage container includes a bottle, with a connector connected to a neck of the bottle. A substantially annular gasket is positioned between the neck of the bottle and the connector to provide a seal along an interface therebetween. An inlet tube and an outlet tube are connected to the connector, with the connector defining an inlet flow path extending from the inlet tube to an interior of the bottle and an outlet flow path extending from the outlet tube to the interior of the bottle.

In another aspect, a plasma storage container includes a bottle, with a connector connected to a neck of the bottle. An inlet tube is bonded to an inlet port of the connector, while an outlet tube is bonded to an outlet port of the connector. The connector defines an inlet flow path extending from the inlet tube to an interior of the bottle and an outlet flow path extending from the outlet tube to the interior of the bottle.

In yet another aspect, a plasma storage container includes a bottle, with a connector connected to a neck of the bottle. Inlet and outlet tubes are connected to the connector, with the connector defining an inlet flow path extending from the inlet tube to an interior of the bottle and an outlet flow path extending from the outlet tube to the interior of the bottle. A bottom end of the inlet flow path extends farther into the interior of the bottle than a bottom end of the outlet flow path.

### BRIEF DESCRIPTION OF THE DRAWINGS

FIG. 1 is a front elevational view of components of a plasma storage container according to an aspect of the present disclosure;

FIG. 2 is a side elevational view of the components of the plasma storage container of FIG. 1;

FIG. 3 is an exploded view of a plasma storage container according to an aspect of the present disclosure;

FIG. 4 is a cross-sectional view of an upper portion of a bottle of the plasma storage container of FIGS. 1-3;

FIGS. 5 and 6 are perspective views of a connector of the plasma storage container of FIGS. 1-3; and

FIGS. 7-9 are cross-sectional views of the connector of FIGS. 5 and 6.

### DESCRIPTION OF THE ILLUSTRATED EMBODIMENTS

The embodiments disclosed herein are for the purpose of providing a description of the present subject matter, and it is understood that the subject matter may be embodied in various other forms and combinations not shown in detail. Therefore, specific designs and features disclosed herein are not to be interpreted as limiting the subject matter as defined in the accompanying claims.

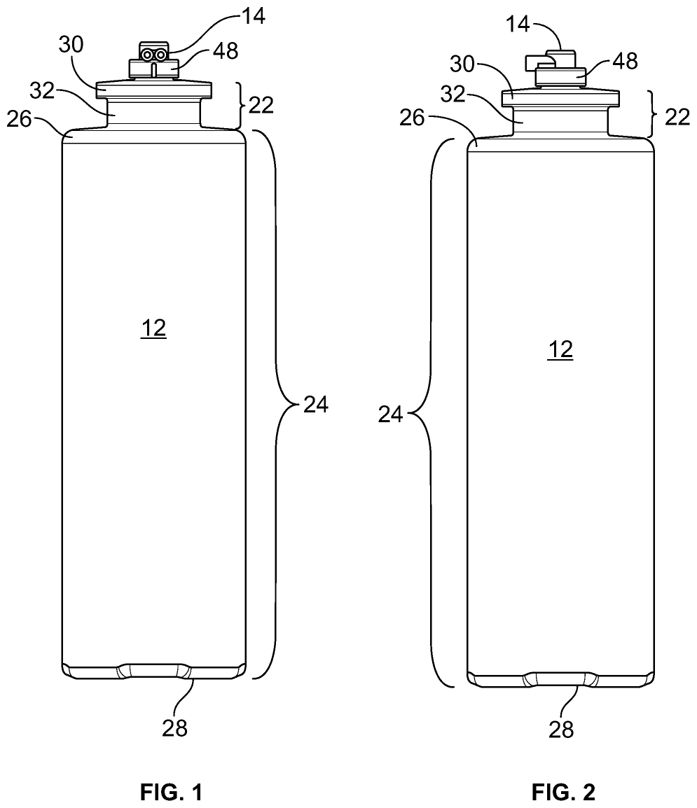

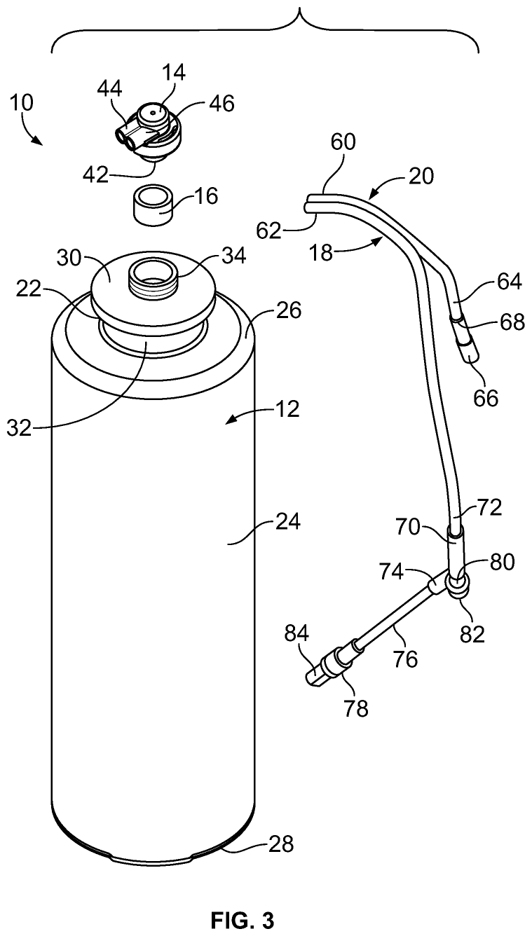

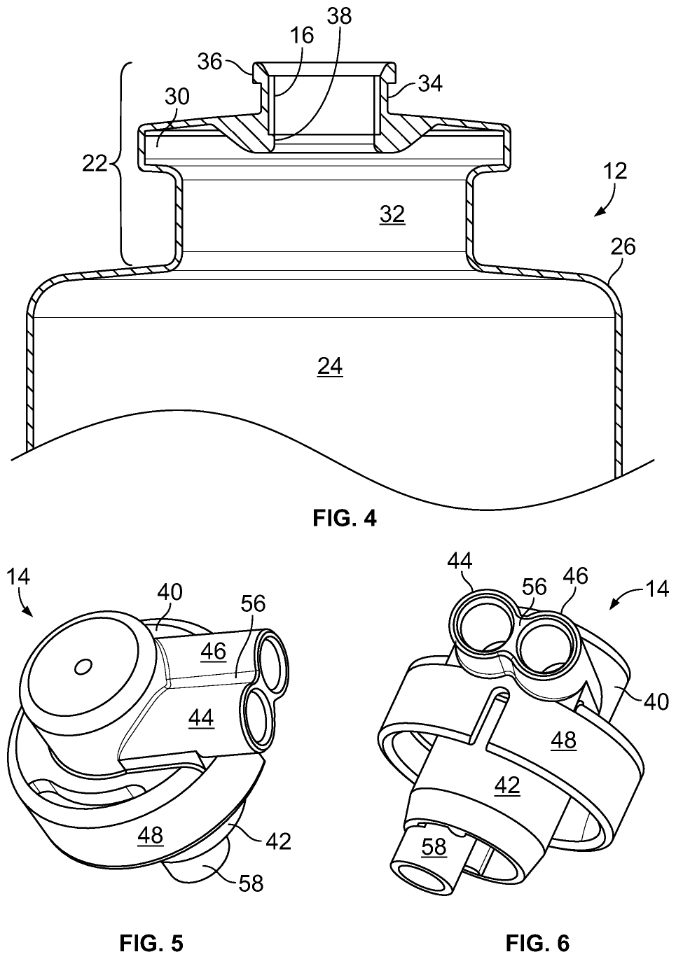

FIGS. 1-3 illustrate an exemplary plasma storage container 10 (FIG. 3) according to the present disclosure. FIGS. 1 and 2 show a bottle 12 and a cap or connector 14 of the container 10, while FIG. 3 additionally shows a gasket 16 and tubes 18 and 20 of the container 10. A neck 22 of the bottle 12 is shown in greater detail in FIG. 4, while the connector 14 is shown in greater detail in FIGS. 5-9.

The bottle 12 of the container 10 includes a body 24 and a neck 22, with the two being joined at a shoulder 26, all of which may be integrally or unitarily formed. The bottle 12 is preferably formed of a deformable or flexible material to accommodate expansion of plasma contained therein when the plasma is frozen for storage. In one embodiment, the bottle 12 is formed of a polymeric material, such as high-density polyethylene (“HDPE”), which is sufficiently deformable or flexible to allow for the expected expansion of the volume of plasma stored therein upon freezing of the plasma and container 10. The manner in which the bottle 12 is manufactured may vary without departing from the scope of the present disclosure and may depend upon the material composition of the bottle 12. For example, when the bottle 12 is formed of a polymeric material, it may be manufactured via a molding procedure, such as a blow molding procedure.

The body 24 and neck 22 of the bottle 12 may be differently sized and configured without departing from the scope of the present disclosure. In addition to being informed by the volume of plasma to be stored therein (which includes the volume of the plasma when frozen and when unfrozen), the configuration of the body 24 and neck 22 of the bottle 12 may be informed by other factors. For example, it is conventional to use a weight scale when filling a plasma storage container with plasma to ensure that the proper volume of plasma is conveyed into the container. It may be the case that the weight scale is only suitable for particularly sized and shaped containers, in which case it would be advantageous for the configuration of the body 24 and neck 22 of the bottle 12 to be informed by the demands of the weight scale and automated device with which the container 10 is expected to be used. In some automated devices, a weight scale is incorporated into a hanger of the device, with a plasma storage container 10 being hung from the hanger by its neck 22. In this case, the configuration of the neck 22 is particularly important to ensure that the container 10 may be used with existing hardware.

Another consideration in the design of the body 24 and neck 22 of the bottle 12 is the storage environment (freezer) in which the container 10 is expected to be retained during long-term storage. When the configuration of the freezer to be used to store a container 10 is known, the configuration of the body 24 and neck 22 of the bottle 12 of the container 10 may be designed to optimize storage of a plurality of identically configured containers 10 in the freezer.

The preferred “aspect ratio” of the body 24 of the bottle 12 (i.e., the relative sizes of its height and diameter) and its internal volume may depend on various factors (as noted above), so the exact dimensions of the body 24 may vary without departing from the scope of the present disclosure. However, in an exemplary embodiment, the body 24 of the bottle 12 has a height (from its base 28 to the bottom of its shoulder 26) in the range of approximately 9.2 inches to approximately 10.1 inches, and more preferably 9.2 to 9.3 inches, with a diameter in the range of approximately 3.2 inches to approximately 3.4 inches, and more preferably 3.2 to 3.3 inches. The body 24 of the bottle 12 may be rounded at its upper and lower ends (i.e., at the shoulder 26 and at the base 28, respectively), which may include a radius of approximately 0.25 inch, for example. The theoretical frozen plasma volume of such a bottle 12 (which accounts for expansion of the plasma during freezing) may be in the range of approximately 1000 mL to approximately 1300 mL, and more preferably around 1200 mL.

The total height of the bottle 12 includes the combined heights of the body 24 and the neck 22, so the height of the neck 22 may be informed by a desired total height of the bottle 12 and a desired height of the body 24. Conversely, if the height and/or configuration of the neck 22 is more important than the height of the body 24 (e.g., if it is advantageous for the neck 22 to be particularly configured to allow for the container 10 to be used with a hanger of a certain automated device), the height of the body 24 may be informed by the desired height of the neck 22 and the desired total height of the bottle 12. In one exemplary embodiment, the total height of the bottle 12 is approximately 10.9 to 11.2 inches, with the neck 22 having a height in the range of approximately 0.8 inch to approximately 1.4 inches.

As shown in greater detail in FIG. 4, the neck 22 of the bottle 12 may include various formations, with the dimensions of each of these formations varying without departing from the scope of the present disclosure. In the illustrated embodiment, the neck 22 includes a flange 30 that is spaced from an upper end of the shoulder 26 by a lower portion 32 of the neck 22 having a diameter that is less than the diameter of the flange 30. An upper portion 34 of the neck 22 extending above the upper end of the flange 30 also has a diameter that is smaller than the diameter of the flange 30, with the diameter of the illustrated upper portion 34 being less than the diameter of the illustrated lower portion 32. In an exemplary embodiment, the lower portion 32 of the neck 22 has a height of approximately 0.5 inch and a diameter of approximately 1.6 inches, the flange 30 has a height of approximately 0.25 to 0.30 inches and a diameter of approximately 2.0 to 2.1 inches, and the upper portion 34 of the neck 22 has a height of approximately 0.3 inch and a diameter of approximately 0.8 inch. It should be understood that the inclusion of these various formations, their relative positions, and their individual configurations is merely exemplary.

In the illustrated embodiment, the upper end of the neck 22 of the bottle 12 includes an outer lip 36 having diameter that is slightly larger than the diameter of the remainder of the upper portion 34 of the neck 22. If provided, such an outer lip 36 may interact with a complementary formation of the connector 14 to allow for a snap-fit between the connector 14 and the bottle 12, with such formation of the connector 14 gripping onto a bottom end of the outer lip 36 to prevent (or at least discourage) removal of the connector 14 from the neck 22 of the bottle 12. In other embodiments, a formation allowing for the connector 14 to be secured to the bottle 12 (e.g., by a snap-fit) may be positioned at a different location of the neck 22 and/or be differently shaped from the illustrated outer lip 36. The inner diameter of the upper end of the neck 22 may be chamfered or tapered (as shown in FIG. 4) to facilitate insertion of the gasket 16 and a portion of the connector 14 into the open upper end of the neck 22 during assembly of the container 10.

In addition to the outer lip 36, the illustrated neck 22 also includes a substantially annular inner lip 38, which provides a seat for the gasket 16. The inner lip 38 is shown in FIG. 4 as being in the same plane as the flange 30, though it should be understood that the inner lip 38 may be positioned at a different elevation within the neck 22 (e.g., at a height that places the inner lip 38 within the lower portion 32 or the upper portion 34 of the neck 22). The position of the inner lip 38 is dependent upon the configuration of the gasket 16, with it being advantageous for the inner lip 38 to be low enough below the uppermost end of the neck 22 to allow for the entire gasket 16 to be received within the neck 22 (as shown in FIG. 4) without a portion of the gasket 16 remaining outside of the neck 22. However, it is within the scope of the present disclosure for the inner lip 38 and gasket 16 to be configured such that a portion of the gasket 16 extends above the uppermost end of the neck 22 of the bottle 12.

As for the gasket 16, it is substantially annular (as best seen in FIG. 3) and provides a seal along an interface between the neck 22 of the bottle 12 and a portion of the connector 14 to ensure the sterility of plasma contained within the bottle 12. The gasket 16 may be fixedly secured to the neck 22 of the bottle 12 or to the connector 14 by any suitable means (e.g., by being bonded or adhered or welded thereto) or may be incorporated into the container 10 without being fixedly secured to either the neck 22 or the connector 14 (e.g., being held in place by a friction and/or interference fit). In order to provide a hermetic seal between the neck 22 and the connector 14, it may be advantageous for the gasket 16 to be formed of a compressible material, such as an elastomeric material. In an exemplary embodiment, the gasket 16 is formed of a silicone elastomer material. As the gasket 16 will typically be used in a low-temperature environment (when plasma within the container 10 is to be frozen), it may be advantageous for the gasket 16 to be formed of a material whose sealant properties are not degraded by such low-temperature environments.

Turning now to the cap or connector 14, it is shown in greater detail in FIGS. 5-9. The connector 14 may be variously configured without departing from the scope of the present disclosure, provided that it is capable of cooperating with the neck 22 of the bottle 12 (and gasket 16, if provided) to hermetically seal the bottle 12 (e.g., as described above), providing a path for plasma to flow into the bottle 12 from any suitable source, and providing a path for a gas (e.g., air) to flow out of the bottle 12 as plasma enters the interior of the bottle 12. The connector 14 may be comprised of multiple components or may be unitarily formed, as a monolithic structure. The connector 14 may be formed of any suitable material or combination of materials, though it may be advantageous for the connector 14 to be formed of a material that may be bonded to the tubes 18 and 20, as will be described in greater detail herein. In an exemplary embodiment, the connector 14 is formed of a thermoplastic polymer material, such as acrylonitrile butadiene styrene (“ABS”), or an acrylic material, such as CYROLITE® G-20 HIFLO.

In the illustrated embodiment, the connector 14 includes a body 40, a downwardly extending stem 42, an inlet port 44, and an outlet port 46. The body 40 includes a substantially annular, downwardly extending rim or skirt 48 that fits around the upper portion 34 of the neck 22 of the bottle 12, as shown in FIGS. 1 and 2. The rim 48 preferably has a height that is less than the height of the upper portion 34 of the neck 22 so as to prevent the flange 30 from interfering with proper association of the connector 14 to the bottle 12. The illustrated rim 48 includes an inwardly extending lip 50 (FIG. 9) that is sized and configured to grip onto the outer lip 36 of the neck 22 of the bottle 12, as described above. In such an embodiment, it may be advantageous for the connector 14 to be formed of a generally rigid, but flexible material (e.g., a plastic) material to allow for the rim 48 to be deformed by contact between the lip 50 of the rim 48 and the outer lip 36 of the neck 22 of the bottle 12 as the connector 14 is pressed onto the neck 22 of the bottle 12 during assembly of the container 10. Upon further downward movement of the connector 14 with respect to the bottle 12, the lip 50 of the rim 48 will bypass or traverse the outer lip 36 of the neck 22 and then the rim 48 will elastically return to its initial configuration, with the lip 50 of the rim 48 positioned beneath the outer lip 36 of the neck 22, thus providing a snap-fit that secures the connector 14 to the bottle 12. It should be understood that a snap-fit is only one possible approach to securing the connector 14 to the bottle 12, with other approaches being within the scope of the present disclosure. For example, if the connector 14 is to be secured to the bottle 12 by a threaded connection, the lip 50 of the rim 48 may be replaced with internal threads that mate with external threads of the neck 22 of the bottle 12.

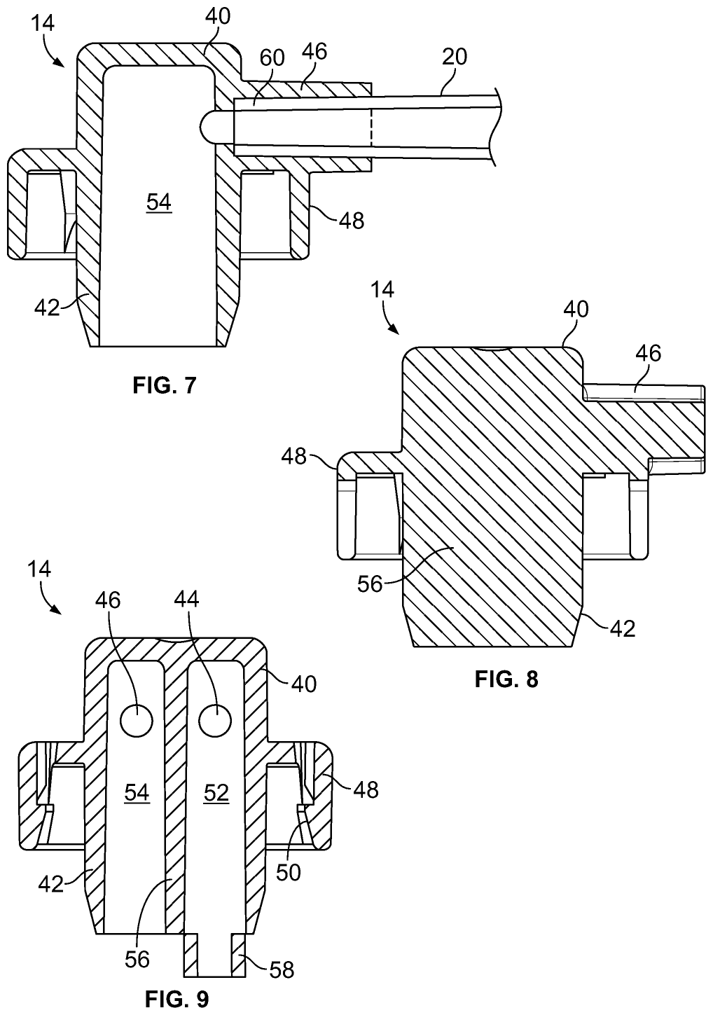

As best shown in FIGS. 7 and 9, the body 40 of the connector 14 defines an inlet flow path 52 extending from the inlet port 44 through the stem 42 (FIG. 9) and an outlet flow path 54 extending from the outlet port 46 through the stem 42 (FIGS. 7 and 9), which allows for fluid communication between the tubes 18 and 20 and the interior of the bottle 12. As shown in FIGS. 8 and 9, a wall or partition 56 is defined between the ports 44 and 46 to separate the inlet flow path 52 from the outlet flow path 54. The inlet flow path 52 allows for the flow of plasma into the bottle 12, while the outlet flow path 54 allows for air in the bottle 14 to flow out of the bottle 14 to accommodate the inflow of plasma.

As can be seen in FIGS. 5, 6, and 9, the stem 42 of the connector 14 may include an extension 58 at the bottom end of the inlet flow path 52, such that the bottom end of the inlet flow path 52 effectively extends farther into the interior of the bottle 12 than the bottom end of the outlet flow path 54. Such a configuration may be advantageous to prevent “cross-flow” or fluid wicking, whereby plasma entering the bottle 12 via the inlet flow path 52 is drawn into the outlet flow path 54 (particularly at low flow rates). If the inlet flow path 52 is provided with an extension 58, the length of the extension 58 may vary without departing from the scope of the present disclosure, though it may be advantageous for the extension 58 to not be so long as to extend into the final filled fluid volume or into a region that could cause the extension 58 to be damaged when the bottle 12 is being prepared for use of a fractionator. While there are advantages to the inlet flow path 52 being elongated compared to the outlet flow path 54, it should be understood that it is within the scope of the present disclosure for the two flow paths 52 and 54 to have the same lengths (i.e., to extend into the interior of the bottle 12 to the same degree) or for the outlet flow path 54 to be elongated compared to the inlet flow path 52 (e.g., by associating the extension 58 to the outlet flow path 54 instead of to the inlet flow path 52). In another embodiment, the inlet flow path 52 may be spaced apart from the outlet flow path 54 to discourage “cross-flow” or fluid wicking.

In addition to defining a portion of the flow paths 52 and 54, the stem 42 may also provide the surface of the connector 14 that engages the gasket 16. In such a configuration, the stem 42 has an outer diameter that is nominally smaller than the inner diameter of the upper portion 34 of the neck 22 of the bottle 12. The stem 42 is pressed into the top opening of the neck 22 of the bottle 12 during assembly of the container 10, which causes the outer surface of the stem 42 to press and compress the gasket 16 against the inner surface of the upper portion 34 of the neck 22, thereby forming a hermetic seal between the connector 14 and the neck 22.

As for the inlet and outlet ports 44 and 46, they may be variously configured without departing from the scope of the present disclosure. In the illustrated embodiment, the ports 44 and 46 are substantially identical to each other (with each being substantially tubular), positioned directly adjacent to each other, and oriented substantially parallel to each other in a direction that is substantially perpendicular to a longitudinal central axis of the bottle 12 (which is a vertical axis in the orientation of FIGS. 1-3). In other embodiments, the ports 44 and 46 may be differently configured, rather than being substantially identical, which may include the ports being differently sized and/or shaped. In still other embodiments, the ports 44 and 46 may be spaced apart from each other, rather than being positioned directly adjacent to each other. In other embodiments, the ports 44 and 46 may be oriented at an angle with respect to each other, rather than being substantially parallel to each other. In still other embodiments, one or both of the ports 44 and 46 may extend in a direction that is not substantially perpendicular to the longitudinal central axis of the bottle 12, which may include one or both ports extending in some other angle with respect to the longitudinal central axis of the bottle 12 or one or both ports extending in a direction that is substantially parallel to the longitudinal central axis of the bottle 12.

Regardless of the particular configuration and orientation of the ports 44 and 46, it is advantageous for each to be configured to accommodate an associated tube 18, 20, with the inlet port 44 accommodating an inlet tube or plasma line 18 and the outlet port 46 accommodating an outlet tube or vent line 20 (which tubes 18 and 20 are shown in FIG. 3). FIG. 7 shows a proximal end 60 of the outlet tube 20 received within the outlet port 46. It should be understood that a proximal end 62 of the inlet tube 18 may be similarly received within the inlet port 44. While the illustrated embodiment employs tubes 18 and 20 that are received within an associated port 44, 46, it should be understood that the tubes 18 and 20 may be otherwise associated to the corresponding ports 44 and 46. This may include a port being pressed into the proximal end of the associated tube or an outermost end of a port being affixed to a proximal-most end of the associated tube (and secured via a butt weld, for example).

In one embodiment of the present disclosure, an outer surface of the proximal end of each tube 18, 20 is bonded to an inner surface of the associated port 44, 46. In an alternative embodiment, an inner surface of the proximal end of each tube 18, 20 is bonded to an outer surface of the associated port 44, 46. If a tube is to be bonded to a port, the material composition of each must be suitable for a bonding procedure. As such, the material composition of the tubes 18 and 20 may be informed by the material composition of the connector 14 or vice-versa. For example, the connector 14 may be formed of a thermoplastic polymer material (such as ABS), in which case the tubes 18 and 20 may be formed of a material that is compatible with bonding to such a connector material, which tube material may include (without limitation) a plasticized polyvinyl chloride (“PVC”) material, such as PL-2286 or PL-2029.

The tubes 18 and 20 may be bonded to the ports 44 and 46 by any suitable approach, which may include, for example, solvent bonding, with the particular solvent depending on the material composition of the tubes 18 and 20 and the connector 14. In one exemplary embodiment, cyclohexane may be a suitable solvent for use with tubes 18 and 20 that are formed of a PVC material. Bonding the tubes 18 and 20 to the ports 44 and 46 may be advantageous compared to conventional techniques (e.g., securing the tubes via a spin welding procedure or a press-fit), which may be prone to breakage and subsequent leakage during the freezing process. Indeed, a bonded connection has been found to provide a secure seal between the tubes 18 and 20 and the ports 44 and 46 when subjected to a freezing process.

Turning now to the tubes 18 and 20, they may be variously configured without departing from the scope of the present disclosure. In the illustrated embodiment (FIG. 3), the tubes 18 and 20 are formed of a flexible material (e.g., a plasticized PVC material, as described above), with the inlet tube 18 being longer than the outlet tube 20. In other embodiments, the outlet tube 20 may be longer than the inlet tube 18 or the two tubes 18 and 20 may be the same length. The tubes 18 and 20 may have the same inner and outer diameters or different inner and/or outer diameters.

A distal end 64 of the outlet tube 20 may include a coupling 66 for connecting the outlet tube 20 to a waste container or the like (for receiving air that has been vented from the interior of the bottle 12). The outlet tube 20 may also (or alternatively) include a filter 68, which may be positioned at any position along the length of the outlet tube 20. In an alternative embodiment, rather than a filter 68 being incorporated into the outlet tube 20, a filter may be incorporated into the outlet flow path 54 defined by the body 40 of the connector 14. In yet another embodiment, filters may be provided in both the outlet tube 20 and the outlet flow path 54. It is also within the scope of the present disclosure for multiple filters to be incorporated into the outlet tube 20 and/or for multiple filters to be incorporated into the outlet flow path 54. Typically, after the container 10 has been filled with plasma, the outlet tube 20 is severed and sealed prior to freezing the container 10 and plasma.

As for the inlet tube 18, the illustrated embodiment includes a Y-connector 70 at its distal end 72. A first branch 74 of the Y-connector 70 includes a conduit 76 fluidically connected to a luer connector 78, while a second branch 80 includes a split septum 82. In such an embodiment, the luer connector 78 (which may be closed by a luer cap 84 when the container 10 is not in use) may be used to connect the inlet tube 18 to a source of plasma, with the split septum 82 being used to connect the inlet tube 18 to a sample container (e.g., via a vacuum tube to draw a portion of plasma flowing toward the inlet port 44 of the connector 14 into the sample container). Typically, after the container 10 has been filled with plasma, the inlet tube 18 is severed and sealed prior to freezing the container 10 and plasma, with the severed (distal) portion of the inlet tube 18 and the Y-connector 70 being discarded.

Again, it should be understood that the illustrated embodiment of the plasma storage container 10 and its individual component is merely exemplary and that the container 10 and its individual components may be differently configured without departing from the scope of the present disclosure. It should also be understood that the various features of the container 10 (e.g., use of a gasket 16, a bottle 12 having a particular “aspect ratio,” tubes 18 and 20 bonded to a connector 14, a unitarily formed connector 14, and a connector 14 defining an inlet flow path 52 that is elongated compared to an outlet flow path 54) may be employed all together, individually, or in various combinations of two or more of such features.

### Aspects

Aspect 1. A plasma storage container, comprising: a bottle including a neck; a connector connected to the neck of the bottle; a substantially annular gasket positioned between the neck of the bottle and the connector to provide a seal along an interface therebetween; an inlet tube connected to the connector; and an outlet tube connected to the connector, wherein the connector defines an inlet flow path extending from the inlet tube to an interior of the bottle, and the connector defines an outlet flow path extending from the outlet tube to the interior of the bottle.
Aspect 2. The plasma storage container of Aspect 1, wherein the connector includes a downwardly extending stem at least partially received within the neck of the bottle.
Aspect 3. The plasma storage container of Aspect 2, wherein the gasket is positioned between an outer surface of the stem of the connector and an inner surface of the neck of the bottle.
Aspect 4. The plasma storage container of any one of the preceding Aspects, wherein the neck of the bottle includes a substantially annular inner lip defining a seat for the gasket.
Aspect 5. The plasma storage container of any one of the preceding Aspects, wherein the gasket is formed of an elastomeric material.
Aspect 6. The plasma storage container of any one of the preceding Aspects, wherein the gasket is formed of a silicone elastomer material.
Aspect 7. The plasma storage container of any one of the preceding Aspects, wherein the connector is configured to be connected to the neck of the bottle via a snap-fit.
Aspect 8. The plasma storage container of any one of the preceding Aspects, wherein the inlet tube is bonded to an inlet port of the connector, and the outlet tube is bonded to an outlet port of the connector.
Aspect 9. The plasma storage container of Aspect 8, wherein an outer surface of a proximal end of the inlet tube is bonded to an inner surface of the inlet port of the connector, and an outer surface of a proximal end of the outlet tube is bonded to an inner surface of the outlet port of the connector.
Aspect 10. The plasma storage container of Aspect 8, wherein an inner surface of a proximal end of the inlet tube is bonded to an outer surface of the inlet port of the connector, and an inner surface of a proximal end of the outlet tube is bonded to an outer surface of the outlet port of the connector.
Aspect 11. The plasma storage container of any one of Aspects 8-10, wherein the bottle includes a longitudinal central axis, and each of the inlet port and the outlet port extends in a substantially perpendicular direction with respect to the longitudinal central axis of the bottle.
Aspect 12. The plasma storage container of any one of Aspects 8-11, wherein the inlet port is oriented directly adjacent to the outlet port.
Aspect 13. The plasma storage container of any one of Aspects 8-12, wherein the inlet port is oriented substantially parallel to the outlet port.
Aspect 14. The plasma storage container of any one of the preceding Aspects, wherein the connector is unitarily formed.
Aspect 15. The plasma storage container of any one of the preceding Aspects, wherein a bottom end of the inlet flow path extends farther into the interior of the bottle than a bottom end of the outlet flow path.
Aspect 16. A plasma storage container, comprising: a bottle including a neck; a connector connected to the neck of the bottle; an inlet tube bonded to an inlet port of the connector; and an outlet tube bonded to an outlet port of the connector, wherein the connector defines an inlet flow path extending from the inlet tube to an interior of the bottle, and the connector defines an outlet flow path extending from the outlet tube to the interior of the bottle.
Aspect 17. The plasma storage container of Aspect 16, wherein an outer surface of a proximal end of the inlet tube is bonded to an inner surface of the inlet port of the connector, and an outer surface of a proximal end of the outlet tube is bonded to an inner surface of the outlet port of the connector.
Aspect 18. The plasma storage container of Aspect 16, wherein an inner surface of a proximal end of the inlet tube is bonded to an outer surface of the inlet port of the connector, and an inner surface of a proximal end of the outlet tube is bonded to an outer surface of the outlet port of the connector.
Aspect 19. The plasma storage container of any one of Aspects 16-18, wherein the bottle includes a longitudinal central axis, and each of the inlet port and the outlet port extends in a substantially perpendicular direction with respect to the longitudinal central axis of the bottle.
Aspect 20. The plasma storage container of any one of Aspects 16-19, wherein the inlet port is oriented directly adjacent to the outlet port.
Aspect 21. The plasma storage container of any one of Aspects 16-20, wherein the inlet port is oriented substantially parallel to the outlet port.
Aspect 22. The plasma storage container of any one of Aspects 16-21, wherein the connector is unitarily formed.
Aspect 23. The plasma storage container of any one of Aspects 16-22, wherein a bottom end of the inlet flow path extends farther into the interior of the bottle than a bottom end of the outlet flow path.
Aspect 24. The plasma storage container of any one of Aspects 16-23, further comprising substantially annular gasket positioned between the neck of the bottle and the connector to provide a seal along an interface therebetween.
Aspect 25. The plasma storage container of Aspect 24, wherein the connector includes a downwardly extending stem at least partially received within the neck of the bottle.
Aspect 26. The plasma storage container of Aspect 25, wherein the gasket is positioned between an outer surface of the stem of the connector and an inner surface of the neck of the bottle.
Aspect 27. The plasma storage container of any one of Aspects 24-26, wherein the neck of the bottle includes a substantially annular inner lip defining a seat for the gasket.
Aspect 28. The plasma storage container of any one of Aspects 24-27, wherein the gasket is formed of an elastomeric material.
Aspect 29. The plasma storage container of any one of Aspects 24-28, wherein the gasket is formed of a silicone elastomer material.
Aspect 30. The plasma storage container of any one of Aspects 16-29, wherein the connector is configured to be connected to the neck of the bottle via a snap-fit.
Aspect 31. A plasma storage container, comprising: a bottle including a neck; a unitary connector connected to the neck of the bottle; an inlet tube connected to the connector; and an outlet tube connected to the connector, wherein the connector defines an inlet flow path extending from the inlet tube to an interior of the bottle, the connector defines an outlet flow path extending from the outlet tube to the interior of the bottle, and the inlet flow path and the outlet flow path are configured to provide a fluid inflow rate that is different from a fluid outflow rate.
Aspect 32. The plasma storage container of Aspect 31, further comprising substantially annular gasket positioned between the neck of the bottle and the connector to provide a seal along an interface therebetween.
Aspect 33. The plasma storage container of Aspect 32, wherein the connector includes a downwardly extending stem at least partially received within the neck of the bottle.
Aspect 34. The plasma storage container of Aspect 33, wherein the gasket is positioned between an outer surface of the stem of the connector and an inner surface of the neck of the bottle.
Aspect 35. The plasma storage container of any one of Aspects 32-34, wherein the neck of the bottle includes a substantially annular inner lip defining a seat for the gasket.
Aspect 36. The plasma storage container of any one of Aspects 32-35, wherein the gasket is formed of an elastomeric material.
Aspect 37. The plasma storage container of any one of Aspects 32-36, wherein the gasket is formed of a silicone elastomer material.
Aspect 38. The plasma storage container of any one of Aspects 31-37, wherein the connector is configured to be connected to the neck of the bottle via a snap-fit.
Aspect 39. The plasma storage container of any one of Aspects 31-38, wherein the inlet tube is bonded to an inlet port of the connector, and the outlet tube is bonded to an outlet port of the connector.
Aspect 40. The plasma storage container of Aspect 39, wherein an outer surface of a proximal end of the inlet tube is bonded to an inner surface of the inlet port of the connector, and an outer surface of a proximal end of the outlet tube is bonded to an inner surface of the outlet port of the connector.
Aspect 41. The plasma storage container of Aspect 39, wherein an inner surface of a proximal end of the inlet tube is bonded to an outer surface of the inlet port of the connector, and an inner surface of a proximal end of the outlet tube is bonded to an outer surface of the outlet port of the connector.
Aspect 42. The plasma storage container of any one of Aspects 39-41, wherein the bottle includes a longitudinal central axis, and each of the inlet port and the outlet port extends in a substantially perpendicular direction with respect to the longitudinal central axis of the bottle.
Aspect 43. The plasma storage container of any one of Aspects 39-42, wherein the inlet port is oriented directly adjacent to the outlet port.
Aspect 44. The plasma storage container of any one of Aspects 39-43, wherein the inlet port is oriented substantially parallel to the outlet port.
Aspect 45. The plasma storage container of any one of Aspects 31-44, wherein the connector is unitarily formed.

It will be understood that the embodiments and examples described above are illustrative of some of the applications of the principles of the present subject matter. Numerous modifications may be made by those skilled in the art without departing from the spirit and scope of the claimed subject matter, including those combinations of features that are individually disclosed or claimed herein. For these reasons, the scope hereof is not limited to the above description but is as set forth in the following claims, and it is understood that claims may be directed to the features hereof, including as combinations of features that are individually disclosed or claimed herein.

1-30. (canceled)

31. A plasma storage container, comprising:
a bottle including a neck;
a connector connected to the neck of the bottle;
an inlet tube connected to the connector; and
an outlet tube connected to the connector, wherein
the connector defines an inlet flow path extending from the inlet tube to an interior of the bottle,
the connector defines an outlet flow path extending from the outlet tube to the interior of the bottle, and
a bottom end of the inlet flow path extends farther into the interior of the bottle than a bottom end of the outlet flow path.

32. The plasma storage container of claim 31, further comprising substantially annular gasket positioned between the neck of the bottle and the connector to provide a seal along an interface therebetween.

33. The plasma storage container of claim 32, wherein the connector includes a downwardly extending stem at least partially received within the neck of the bottle.

34. The plasma storage container of claim 33, wherein the gasket is positioned between an outer surface of the stem of the connector and an inner surface of the neck of the bottle.

35. The plasma storage container of claim 32, wherein the neck of the bottle includes a substantially annular inner lip defining a seat for the gasket.

36. The plasma storage container of claim 32, wherein the gasket is formed of an elastomeric material.

37. The plasma storage container of claim 32, wherein the gasket is formed of a silicone elastomer material.

38. The plasma storage container of claim 31, wherein the connector is configured to be connected to the neck of the bottle via a snap-fit.

39. The plasma storage container of claim 31, wherein
the inlet tube is bonded to an inlet port of the connector, and
the outlet tube is bonded to an outlet port of the connector.

40. The plasma storage container of claim 39, wherein
an outer surface of a proximal end of the inlet tube is bonded to an inner surface of the inlet port of the connector, and
an outer surface of a proximal end of the outlet tube is bonded to an inner surface of the outlet port of the connector.

41. The plasma storage container of claim 39, wherein
an inner surface of a proximal end of the inlet tube is bonded to an outer surface of the inlet port of the connector, and
an inner surface of a proximal end of the outlet tube is bonded to an outer surface of the outlet port of the connector.

42. The plasma storage container of claim 39, wherein
the bottle includes a longitudinal central axis, and
each of the inlet port and the outlet port extends in a substantially perpendicular direction with respect to the longitudinal central axis of the bottle.

43. The plasma storage container of claim 39, wherein the inlet port is oriented directly adjacent to the outlet port.

44. The plasma storage container of claim 39, wherein the inlet port is oriented substantially parallel to the outlet port.

45. The plasma storage container of claim 31, wherein the connector is unitarily formed.
